(19) United States
(12) Patent Application Publication
(10) Pub. No.: US 2023/0072223 A1
(43) Pub. Date: Mar. 9, 2023

(54) RESIN COMPOSITION

(71) Applicant: NAN YA PLASTICS CORPORATION, TAIPEI (TW)

(72) Inventors: Te-Chao Liao, TAIPEI (TW); Wei-Ru Huang, TAIPEI (TW); Hung-Yi Chang, TAIPEI (TW); Chia-Lin Liu, TAIPEI (TW); Chien Kai Wei, TAIPEI (TW)

(73) Assignee: NAN YA PLASTICS CORPORATION, TAIPEI (TW)

(21) Appl. No.: 17/549,880

(22) Filed: Dec. 14, 2021

(30) Foreign Application Priority Data
Aug. 24, 2021 (TW) 110131329

(51) Int. Cl. C08F 136/06; C08L 71/12; C08K 3/36; C08K 5/14; C08K 5/3492; C08K 5/5419; C08K 5/5313

(52) U.S. Cl. CPC C08F 136/06; C08L 71/126; C08K 3/36; C08K 5/14; C08K 5/34924; C08K 5/5419; C08K 5/5313; C08L 2203/20

(57) ABSTRACT

A resin composition, including resin and peroxide, is provided. The resin includes liquid rubber resin, polyphenylene ether resin, and a crosslinking agent. The sum of the liquid rubber resin, the polyphenylene ether resin, and the crosslinking agent is 100 parts by mass. The amount of the peroxide used is between 0.1 phr and 5 phr. The peroxide is composed of tertiary butyl cumyl peroxide and an inorganic compound.

### CROSS-REFERENCE TO RELATED APPLICATION

This application claims the priority benefit of Taiwan application serial no. 110131329, filed on Aug. 24, 2021. The entirety of the above-mentioned patent application is hereby incorporated by reference herein and made a part of this specification.

### BACKGROUND

### Technical Field

The disclosure relates to a composition, and particularly relates to a resin composition.

### Description of Related Art

The new generation of electronic products tend to be light, thin, short, and small, and suitable for high-frequency transmission. Therefore, the wiring of the circuit board is becoming denser, and the material selection of the circuit board is becoming more rigorous. In terms of electrical properties, the main considerations include the dielectric constant (Dk) and the dielectric loss (also known as the dissipation factor, Df) of the material. Generally speaking, since the signal transmission speed of the substrate is inversely proportional to the square root of the dielectric constant of the substrate material, the dielectric constant of the substrate material is usually as small as possible. On the other hand, since the smaller the dielectric loss, the less the signal transmission loss, the material with smaller dielectric loss can provide better transmission quality. High-frequency electronic elements are bonded to the circuit board, and in order to maintain the transmission rate and the integrity of the transmission signal, the substrate material of the circuit board must have a low dielectric constant and dielectric loss.

Furthermore, in order to be suitable for high-frequency and high-speed substrates, a relatively high proportion of liquid rubber resin is usually added into the resin composition currently used to manufacture substrates. However, adding a large amount of liquid rubber causes a relatively high viscosity and poor flow and filling properties, resulting in a decrease in the overall processability.

### SUMMARY

The disclosure provides a resin composition, which can effectively improve the overall processability.

A resin composition of the disclosure includes resin and peroxide. The resin includes liquid rubber resin, polyphenylene ether resin, and a crosslinking agent. A sum of the liquid rubber resin, the polyphenylene ether resin, and the crosslinking agent is 100 parts by mass. An amount of the peroxide used is between 0.1 phr and 5 phr. The peroxide is composed of tertiary butyl cumyl peroxide and an inorganic compound.

In an embodiment of the disclosure, the tertiary butyl cumyl peroxide includes 1,3 1,4-bis(tert-butylperoxyisopropyl)benzene, and the inorganic compound includes one or more of spherical or irregular SiO₂, TiO₂, Al(OH)₃, Al₂O₃, Mg(OH)₂, MgO, CaCO₃, B₂O₃, CaO, SrTiO₃, BaTiO₃, CaTiO₃, 2MgO.TiO₂, CeO₂ or fume silica, BN, and AlN.

In an embodiment of the disclosure, the peroxide contains active oxygen in a proportion between 3% and 10%.

In an embodiment of the disclosure, the tertiary butyl cumyl peroxide accounts for 40% to 50% of a weight of the peroxide.

In an embodiment of the disclosure, a molecular weight of the peroxide is between 300 g/mole and 500 g/mole.

In an embodiment of the disclosure, a proportion of the liquid rubber resin used in the resin is between 20 wt % and 50 wt %, a proportion of the polyphenylene ether resin used in the resin is between 10 wt % and 60 wt %, and a proportion of the crosslinking agent used in the resin is between 5 wt % and 30 wt %.

In an embodiment of the disclosure, the resin composition further includes at least one of a flame retardant, an inorganic filler, and silane.

In an embodiment of the disclosure, an amount of the silane used is between 0.1 phr and 5 phr.

In an embodiment of the disclosure, a resin flow rate of the resin composition is at least greater than or equal to 18%.

In an embodiment of the disclosure, a dielectric constant of a substrate made of the resin composition is between 2.8 and 3.2, and a dielectric loss is less than 0.003.

Based on the above, for the resin composition of the disclosure, by selecting preferable peroxide and amount of the peroxide used, that is, using the peroxide composed of the tertiary butyl cumyl peroxide and the inorganic compound and the amount of the peroxide used being between 0.1 phr and 5 phr, the resin flow can be improved while maintaining the electrical properties required by the substrate, so the overall processability can be effectively improved.

In order for the features and advantages of the disclosure to be more comprehensible, the following embodiments are cited and described in detail as follows.

### BRIEF DESCRIPTION OF THE DRAWINGS

None.

### DETAILED DESCRIPTION OF DISCLOSED EMBODIMENTS

In the embodiment, a resin composition includes resin, wherein the resin includes liquid rubber resin, polyphenylene ether resin, and a crosslinking agent, wherein the sum of the liquid rubber resin, the polyphenylene ether resin, and the crosslinking agent is 100 parts by mass. In addition, in order to effectively improve the overall processability, the resin composition of the embodiment includes peroxide, wherein the peroxide is composed of tertiary butyl cumyl peroxide and an inorganic compound, and the amount of the peroxide used is between 0.1 phr and 5 phr (for example, 0.1 phr, 0.5 phr, 1 phr, 1.5 phr, 2 phr, 2.5 phr, 3 phr, 3.5 phr, 4 phr, 4.5 phr, 5 phr, or any value within 0.1 phr to 5 phr). Accordingly, the resin composition of the embodiment can improve the resin flow while maintaining the electrical properties required by a substrate by selecting preferable peroxide and amount of the peroxide used, so the overall processability can be effectively improved. Here, the unit phr may be defined as parts by mass of other materials added to every 100 parts by mass of the resin.

Furthermore, peroxides (such as LUPEROX F FLAKES from Arkema) are often used in current resin compositions to initiate free radical crosslinking polymerization reaction. However, the peroxides often initiate a crosslinking reaction at a low temperature stage (for example, 120° C. or 130° C.), which causes a relatively large change in viscosity, resulting in high viscosity at the low temperature stage. As a result, the resin flow and filling properties will be poor, resulting in a decrease in the overall processability. Therefore, the embodiment uses the peroxide composed of the tertiary butyl cumyl peroxide and the inorganic compound, and the amount of the peroxide used is between 0.1 phr and 5 phr. The rate of free radicals generated by the peroxide cracking at the same temperature becomes slower, thereby increasing the resin flow during processing. In other words, the peroxide of the embodiment can delay the crosslinking reaction of the resin in the resin composition at the low temperature stage.

For example, the resin flow rate of the resin composition is at least greater than or equal to 18%, and the dielectric constant of the substrate made of the resin composition is between 2.8 and 3.2 and the dielectric loss is less than 0.003, but the disclosure is not limited thereto.

In some embodiments, the peroxide is formed by hybrid modification of the tertiary butyl cumyl peroxide and the inorganic compound, wherein the hybrid modification method may be any hybrid modification method known to persons skilled in the art and is not limited by the disclosure.

In some embodiments, the peroxide contains active oxygen in a proportion between 3% and 10% (for example, 3%, 4%, 5%, 6%, 7%, 8%, 9%, 10%, or any value within 3% to 10%), but the disclosure is not limited thereto.

In some embodiments, the tertiary butyl cumyl peroxide accounts for 40% to 50% (for example, 40%, 41%, 42%, 43%, 44%, 45%, 46%, 47%, 48%, 49%, 50%, or any value within 40% to 50%) of the weight of the peroxide, but the disclosure is not limited thereto.

In some embodiments, the molecular weight of the peroxide is between 300 g/mole and 500 g/mole (for example, 300 g/mole, 350 g/mole, 400 g/mole, 450 g/mole, 500 g/mole, or any value within 300 g/mole to 500 g/mole), but the disclosure is not limited thereto.

In some embodiments, the tertiary butyl cumyl peroxide includes 1,3 1,4-bis(tert-butylperoxyisopropyl)benzene, and the inorganic compound includes one or more of spherical or irregular SiO₂, TiO₂, Al(OH)₃, Al₂O₃, Mg(OH)₂, MgO, CaCO₃, B₂O₃, CaO, SrTiO₃, BaTiO₃, CaTiO₃, 2MgO.TiO₂, CeO₂ or fume silica, BN, and AlN, wherein the structural formula of the 1,3 1,4-bis(tert-butylperoxyisopropyl)benzene is shown below. In addition, specific examples of the tertiary butyl cumyl peroxide include, but are not limited to, LUPEROX F40P-SP2, which may be available from ARKEMA.

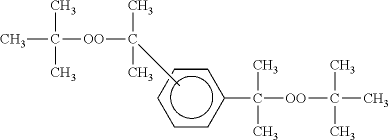

Furthermore, the peroxide may be used to accelerate the crosslinking reaction at different temperatures. When the resin composition of the embodiment is heated, the peroxide decomposes to form free radicals at a specific temperature to further initiate the free radical crosslinking polymerization reaction. As the temperature increases, the peroxide depletes faster. Therefore, there is the issue of compatibility between the peroxide and the resin composition, but the disclosure is not limited thereto.

In some embodiments, the proportion of the liquid rubber resin used in the resin is between 20 wt % and 50 wt % (for example, 20 wt %, 25 wt %, 30 wt %, 40 wt %, 50 wt %, or any value within 20 wt % to 50 wt %), the proportion of the polyphenylene ether resin used in the resin is between 10 wt % and 60 wt % (for example, 10 wt %, 22 wt %, 30 wt %, 40 wt %, 50 wt %, 60 wt %, or any value within 10 wt % to 60 wt %), and the proportion of the crosslinking agent used in the resin is between 5 wt % and 30 wt % (for example, 5 wt %, 10 wt %, 15 wt %, 20 wt %, 25 wt %, 30 wt %, or any value within 5 wt % to 30 wt %), but the disclosure is not limited thereto.

In some embodiments, the liquid rubber resin may be polybutadiene and may have the following structure, where n=15 to 25, and preferably n=16 to 22:

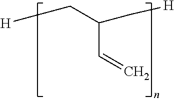

In some embodiments, the liquid rubber resin may be polyolefin and includes, but is not limited to,: styrene-butadiene-divinylbenzene terpolymer, styrene-butadiene-maleic anhydride terpolymer, vinyl-polybutadiene-urethane oligomer, styrene-butadiene copolymer, hydrogenated styrene-butadiene copolymer, styrene-isoprene copolymer, hydrogenated styrene-isoprene copolymer, hydrogenated styrene-butadiene-divinylbenzene copolymer, polybutadiene (homopolymer of butadiene), maleic anhydride-styrene-butadiene copolymer, methyl styrene copolymer, or a group formed by a combination thereof.

In some embodiments, the liquid rubber resin has 10% to 90% 1,2-vinyl and 0% to 60% styrene, and the molecular weight may be between 1000 and 5000 to effectively crosslink with other resins and improve compatibility, but the disclosure is not limited thereto.

In some embodiments, the polyphenylene ether resin is thermosetting polyphenylene ether resin and is a composition with terminal groups having styrene-type polyphenylene ether and terminal acrylic polyphenylene ether. For example, the structure of the styrene-type polyphenylene ether is shown in Structural Formula (A):

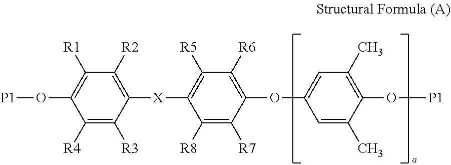

where R1 to R8 may be an allyl group, a hydrogen group, a C1 to C6 alkyl group, or selected from one or more of the above groups, X may be O (oxygen atom),

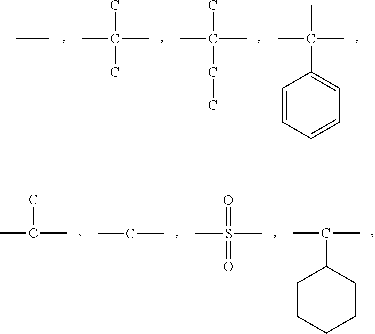

P1 is styrene,

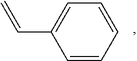

and a is an integer from 1 to 99.

The structure of the terminal acrylic polyphenylene ether is shown in Structural Formula (B):

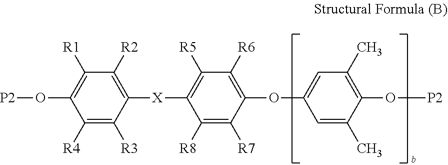

where R1 to R8 may be an allyl group, a hydrogen group, a C1 to C6 alkyl group, or selected from one or more of the above groups, X may be O (oxygen atom),

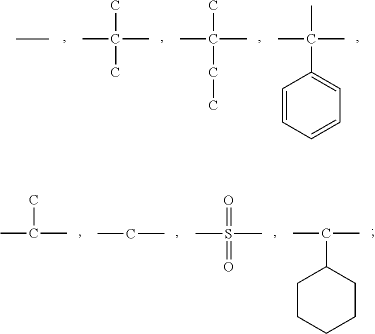

### P2 is

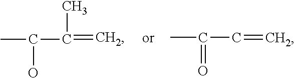

and b is an integer from 1 to 99.

Specific examples of the polyphenylene ether resin includes, but is not limited to, bishydroxy polyphenylene ether resin (for example, SA-90, which may be available from Sabic), vinyl benzyl polyphenylene ether resin (for example, OPE-2st, which may be available from Mitsubishi Gas Chemical Company), methacrylate polyphenylene ether resin (for example, SA-9000, which may be available from Sabic Company), vinyl benzyl modified bisphenol A polyphenylene ether resin, or vinyl chain-extended polyphenylene ether resin. The polyphenylene ether is preferably vinyl polyphenylene ether.

In some embodiments, the crosslinking agent is used to increase the degree of crosslinking of thermosetting resin, adjust the rigidity and toughness of the substrate, and adjust the processability. The type of the crosslinking agent used may be 1,3,5-triallyl cyanurate (TAC), triallyl isocyanurate (TAIL), trimethylallyl isocyanurate (TMAIC), diallyl phthalate, divinylbenzene, 1,2,4-triallyl trimellitate, etc., or a combination of one or more of the above.

In some embodiments, the resin composition further includes at least one selected from the following groups: a flame retardant, an inorganic filler, and silane.

In some embodiments, compared to a total of 100 parts by mass of the resin, the amount of the flame retardant adopted in the disclosure is not particularly limited, which may be, for example, 1 part by weight to 100 parts by mass, 10 parts by mass to 90 parts by mass, 20 parts by mass to 80 parts by mass, 30 parts by mass to 70 parts by mass, or 40 parts by mass to 60 parts by mass.

In some embodiments, the flame retardant may be a halogen-free flame retardant, and a specific example of the flame retardant may be a phosphorus flame retardant, which may be selected from phosphates, such as TPP, RDP, BPAPP, BBC, CR-733S, and PX-200; may be selected from phosphazenes such as SPB-100; ammonium polyphosphate, melamine polyphosphate (MPP), and melamine cyanurate; may be selected from more than one combinations of DOPO flame retardants, such as DOPO (for example, Structural Formula (C)), DOPO-HQ (for example, Structural Formula (D)), double DOPO derivative structure (for example, Structural Formula (E)), etc.; and aluminum-containing hypophosphites (for example, Structural Formula (F)).

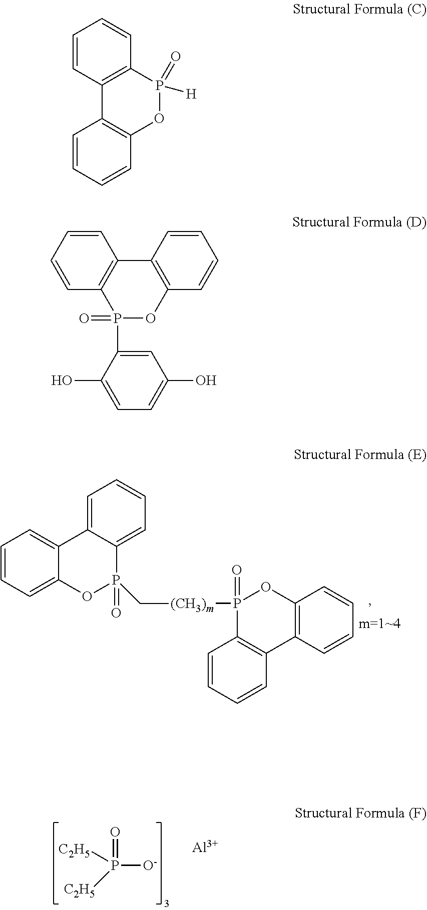

In some embodiments, compared to the total of 100 parts by mass of the resin composition, the amount of the inorganic filler adopted in the disclosure is not particularly limited, which may be, for example, 20 parts by mass to 50 parts by mass, 20 parts by mass to 40 parts by mass, or any other suitable parts by mass, wherein the purpose of the inorganic filler is mainly to improve the mechanical strength and dimensional stability of the resin composition after hardening. The composition of the inorganic filler is selected from one or more of spherical or irregular SiO₂, TiO₂, Al(OH)₃, Al₂O₃, Mg(OH)₂, MgO, CaCO₃, B₂O₃, CaO, SrTiO₃, BaTiO₃, CaTiO₃, 2MgO.TiO₂, CeO₂ or fume silica, BN, and AlN. The average particle size of the inorganic filler is preferably 0.01 microns to 20 microns. The fume silica is a porous nano-sized silica particle with an addition proportion of 0.1 wt % to 10 wt % and an average particle size of 1 to 100 nm. In addition, SiO₂ may be molten or crystalline. Considering the dielectric properties of the composition, SiO₂ is preferably molten silicon dioxide, such as 525ARI of Bao Lin.

In some embodiments, the amount of the silane used is between 0.1 phr and 5 phr (for example, 0.1 phr, 0.5 phr, 1 phr, 1.5 phr, 2 phr, 2.5 phr, 3 phr, 3.5 phr, 4 phr, 4.5 phr, 5 phr, or any value within 0.1 phr to 5 phr) to enhance the material compatibility and the degree of crosslinking. The silane may include, but is not limited to, siloxane. In addition, according to the type of functional groups, the silane may be divided into amino silane, epoxy silane, vinyl silane, ester silane, hydroxy silane, isocyanate silane, methylacryloxy silane, and acryloxy silane.

It should be noted that the resin composition of the disclosure may be processed into a prepreg and a copper clad laminate (CCL) according to actual design requirements. Therefore, the prepreg and the copper clad laminate manufactured by using the resin composition of the disclosure also have better reliability (can maintain the required electrical properties). In addition, the specific embodiments listed above are not a limitation of the disclosure, as long as the resin composition includes the peroxide, wherein the peroxide is composed of the tertiary butyl cumyl peroxide and the inorganic compound, and the amount of the peroxide used is between 0.1 phr and 5 phr, all are within the protection scope of the disclosure.

The following examples and comparative examples are listed to illustrate the effects of the disclosure, but the scope of rights of the disclosure is not limited to the scope of the examples.

The copper clad laminates manufactured in the respective examples and comparative examples were evaluated according to the following methods.

The glass transition temperature (° C.) was tested by a dynamic mechanical analyzer (DMA).

Water absorption (%): After the sample was heated in a pressure cooker at 120° C. and 2 atm for 120 minutes, the amount of change in weight before and after heating was calculated.

288° C. solder resistance and heat resistance (seconds): After the sample was heated in a pressure cooker at 120° C. and 2 atm for 120 minutes, the sample was immersed in a 288° C. solder furnace, and the time required for the sample to delaminate was recorded.

Dielectric constant Dk: The dielectric constant Dk at a frequency of 10 GHz was tested by the dielectric analyzer HP Agilent E4991A.

Dielectric loss Df: The dielectric loss Df at a frequency of 10 GHz was tested by the dielectric analyzer HP Agilent E4991A.

Resin flow rate: A press at 170° C. plus or minus 2.8° C. was used to depress at 200 PSI plus or minus 25 PSI for 10 minutes. After fusion and cooling, a disc was punched out. The disc was fine-weighed, and the amount of outflow of the resin was calculated.

### EXAMPLES 1 TO 3, COMPARATIVE EXAMPLE 1

The resin composition shown in Table 1 was mixed with toluene to form a varnish of thermosetting resin composition. The varnish was impregnated with Nan Ya fiberglass cloth (cloth type 1078LD from Nan Ya Plastics Corporation) at room temperature. Then, after drying for several minutes at 170° C. (impregnator), a prepreg with a resin content of 79 wt % was obtained. Finally, 4 pieces of the prepreg were stacked layer by layer between two layers of 35 μm thick copper foils. Under a pressure of 25 kg/cm² and a temperature of 85° C., a constant temperature was kept for 20 minutes. Then, after heating to 210° C. at a heating rate of 3° C./min, a constant temperature was kept again for 120 minutes. Then, slowly cool down to 130° C. to obtain a 0.59 mm thick copper clad laminate.

The physical properties of the manufactured copper clad laminate were tested, and the results are shown in Table 1. After comparing the results of Examples 1 to 3 and Comparative Example 1 in Table 1, the following conclusion can be drawn: Compared to Comparative Example 1, Examples 1 to 3 can improve the resin flow while maintaining the required electrical properties of the substrate, so the overall processability can be effectively improved.

TABLE 1

| | | Example | | | Comparative |
|---|---|---|---|---|---|
| | | 1 | 2 | 3 | Example 1 |
| Resin | Liquid rubber resin | 25 | 25 | 25 | 25 |
| (100 parts | (polybutadiene) (wt %) | | | | |
| by mass | Polyphenylene ether resin | 45 | 45 | 45 | 45 |
| in total) | (methacrylate-terminated | | | | |
| | polyphenylene ether resin) | | | | |
| | (wt %) | | | | |
| | Crosslinking agent (TAIC) | 30 | 30 | 30 | 30 |
| | (wt %) | | | | |
| Other | Halogen-free flame | 30 | 30 | 30 | 30 |
| additives | retardant (PQ60) (phr) | | | | |
| (relative | Inorganic filler (spherical | 40 | 40 | 40 | 40 |
| to 100 | SiO₂) (phr) | | | | |
| parts by | Peroxide (Luperox F | — | — | — | 0.6 |
| mass of | FLAKES) (phr) | | | | |
| resin) | Peroxide (Luperox | 1.2 | 1.5 | 3.0 | — |
| | F40P-SP2) (phr) | | | | |
| | Silane (methylacryloxy | 0.5 | 0.5 | 0.5 | 0.5 |
| | silane) (phr) | | | | |

| | | | | |
|---|---|---|---|---|
| B-stage curing temperature (° C.) | 170 | 170 | 170 | 170 |
| Glass transition temperature (° C.) | 187 | 196 | 239 | 210 |
| Water absorption (PCT ½ hour) (%) | 0.14 | 0.25 | 0.22 | 0.21 |
| Heat resistance (PCT ½ hour) | Pass | Pass | Pass | Pass |
| Water absorption (PCT 2 hours) (%) | 0.26 | 0.27 | 0.25 | 0.26 |
| Heat resistance (PCT 2 hours) | Pass | Pass | Pass | Pass |
| Dielectric constant (Dk) | 3.09 | 3.09 | 3.06 | 3.09 |
| (measurement frequency 10 GHz) | | | | |
| Loss factor (Df) (measurement | 0.0015 | 0.0018 | 0.0022 | 0.0018 |
| frequency 10 GHz) | | | | |
| Resin flow (%) | 18 | 22 | 29 | 12 |

In summary, for the resin composition of the disclosure, by selecting preferable peroxide and amount of the peroxide used, that is, using the peroxide composed of the tertiary butyl cumyl peroxide and the inorganic compound and the amount of the peroxide used being between 0.1 phr and 5 phr, the resin flow can be improved while maintaining the electrical properties required by the substrate, so the overall processability can be effectively improved.

Although the disclosure has been disclosed in the above embodiments, the embodiments are not intended to limit the disclosure. Persons skilled in the art may make some changes and modifications without departing from the spirit and scope of the disclosure. The protection scope of the disclosure shall be defined by the appended claims.

What is claimed is:

1. A resin composition, comprising:
resin, comprising liquid rubber resin, polyphenylene ether resin, and a crosslinking agent, wherein a sum of the liquid rubber resin, the polyphenylene ether resin, and the crosslinking agent is 100 parts by mass; and
peroxide, wherein an amount of the peroxide used is between 0.1 phr and 5 phr, and the peroxide is composed of tertiary butyl cumyl peroxide and an inorganic compound.

2. The resin composition according to claim 1, wherein the tertiary butyl cumyl peroxide comprises 1,3 1,4-bis(tert-butylperoxyisopropyl)benzene, and the inorganic compound comprises one or more of spherical or irregular SiO₂, TiO₂, Al(OH)₃, Al₂O₃, Mg(OH)₂, MgO, CaCO₃, B₂O₃, CaO, SrTiO₃, BaTiO₃, CaTiO₃, 2MgO.TiO₂, CeO₂, fume silica, BN, and AlN.

3. The resin composition according to claim 1, wherein the peroxide contains active oxygen in a proportion between 3% and 10%.

4. The resin composition according to claim 1, wherein the tertiary butyl cumyl peroxide accounts for 40% to 50% of a weight of the peroxide.

5. The resin composition according to claim 1, wherein a molecular weight of the peroxide is between 300 g/mole and 500 g/mole.

6. The resin composition according to claim 1, wherein a proportion of the liquid rubber resin used in the resin is between 20 wt % and 50 wt %, a proportion of the polyphenylene ether resin used in the resin is between 10 wt % and 60 wt %, and a proportion of the crosslinking agent used in the resin is between 5 wt % and 30 wt %.

7. The resin composition according to claim 1, further comprising at least one of a flame retardant, an inorganic filler, and silane.

8. The resin composition according to claim 7, wherein an amount of the silane used is between 0.1 phr and 5 phr.

9. The resin composition according to claim 1, wherein a resin flow rate of the resin composition is at least greater than or equal to 18%.

10. The resin composition according to claim 1, wherein a dielectric constant of a substrate made of the resin composition is between 2.8 and 3.2, and a dielectric loss is less than 0.003.
